(19) United States
(12) Patent Application Publication
(10) Pub. No.: US 2010/0303994 A1
(43) Pub. Date: Dec. 2, 2010

(54) METHOD FOR BREWING BEER

(76) Inventor: Guido Aerts, Lovendegem (BE)

Correspondence Address: CLARK & ELBING LLP, 101 FEDERAL STREET, BOSTON, MA, 02110, US

(21) Appl. No.: 12/738,569

(22) PCT Filed: Oct. 20, 2008
(86) PCT No.: PCT/BE08/00081

§ 371 Date: Aug. 17, 2010

(30) Foreign Application Priority Data
Oct. 19, 2007 (GB) 0720423.3

(51) Int. Cl. C12C 11/00

(52) U.S. Cl. 426/592; 426/16

(57) ABSTRACT

The present invention relates to a method for brewing bottom fermented beer, such method comprising the use of cereal bran, preferably wheat or rye bran, at a ratio of 15% to 50% of the grist. The method of the present invention allows the brewing of beers having an excellent taste and taste stability during ageing at a comparatively low raw material cost.

### FIELD OF THE INVENTION

The present invention relates to a method for brewing bottom fermented beer, such method comprising the use of cereal bran, preferably wheat bran or rye bran, at a ratio of more than 10%, preferably at a ratio of at least 15% and up to 40% (w/w) of the grist. The method of the present invention allows for the brewing of beers having an excellent taste and taste stability during ageing at a comparatively low raw material cost.

### BACKGROUND OF THE INVENTION

Malted cereals, in particular malted barley, are the main ingredient used for beer brewing. Malted cereals provide both the polysaccharides and the enzymes for converting the polysaccharides into simple monosaccharides and oligosaccharides that can be fermented by yeast to ethanol and carbon dioxide. In the beer making process, malt can be substituted in part by other carbohydrate-rich ingredients, which are generally termed adjuncts. Adjuncts used for beer brewing include unmalted cereal grains (such as maize, rice, rye, barley, and wheat), the endosperm fraction of unmalted cereal grains, starch, hydrolysed or partially hydrolysed starch, maltose, glucose, molasses, or sucrose. The reasons for substituting malt by adjuncts can be to reduce costs, alter taste, improve taste stability, alter beer color, or alter foaming or colloidal properties. The most commonly used adjuncts used for brewing clear bottom fermented beers are unmalted maize and unmalted rice, which are mainly used to lower the cost of beer production, as their price is lower than that of barley malt. A problem linked to the use of such adjuncts, however, is that they result in a thinner palate, which correlates with a lower real extract value of the finished beer. There is a need in the art for finding a solution to this problem, if possible, without significantly altering the standard brewing processes. The present invention is based on the surprising finding that a grist comprising more than 10% (w/w), for instance between 15% and 50% (w/w) of bran can be used to brew a bottom fermented beer with an improved taste as well as taste stability.

Cereal bran has been used in the past as an adjunct to make top fermented beers, especially table beer or small beer. Washington (1757), Coppinger (1815) and Byrn (1873) have described processes for making table beer or small beer made on the basis of a mixture of molasses and wheat bran, which are cooked followed by a short top fermentation without maturation. However, these beers, as well as higher alcohol versions made from them, are generally considered not enjoyable by modern taste standards (see for instance a contemporary evaluation in http://brewery.org/brewery/cm3/recs/13 07.html). US81214 disclosed a method for brewing a bottom fermented beer using a grist comprising barley malt, heat treated maize meal, cereal bran, and phosphates. In the disclosed formula for making 10 barrels of beer (approx. 1190 liter), the amounts of barley malt, unmalted maize, wheat bran and oat bran comprised in the grist are 17 bushels (578 pound), 200 pound, 2 bushels (40 pound), and 2 bushels (40 pound), respectively. Conversions of bushel to pound for the different products are made according to information presented in http://archive1.mdarchives.state.md.us/megafile/msa/speccol/sc2900/sc2908/000001/000572/html/am572-1268.html. The content of added wheat bran in the grist of this beer is thus not more than 4.7%, and the combined content of added wheat bran and oat bran is 9.3%. The addition of bran in the brewing recipe of US81214 aimed at compensating the low protein content in the maize meal in order to improve the nutritional composition of the beer. Not withstanding these teachings, the presence of substantial amounts of cereal bran-like materials, such as present in ground whole grains, in a brewing grist is generally avoided as they are considered to have undesired effect on taste and taste stability of beers. The branny taste of bran and cooked bran is well known and is a deterrent for its use at high concentrations in those food and beverage products that are mainly consumed for enjoyment of taste, such as beer.

Taking into account the state of the art on brewing and in particular that on the brewing of clear bottom fermented beers the skilled person will consider cereal bran, including wheat bran and rye bran, to be unsuitable brewing adjuncts because of its low fermentable carbohydrate content (15-30% versus 50-70% for malted cereals), its high protein content (15-20% versus 10-15% for malted cereals), its high brown pigment content, and its high beta-glucan content. An adjunct with a low fermentable carbohydrates content is generally considered undesired for beer brewing because it results in a low fermentation yield. An adjunct with a high protein content is generally considered undesired for brewing clear lager beers because it can cause increased haziness and taste instability of the finished beer. An adjunct with a high pigment content is generally considered unsuited for brewing of clear beers because it can cause a deviation from the desired yellow color. Finally, an adjunct with a high content in beta-glucans is generally considered less suited because the beta-glucans can cause an undesired increase in wort and beer viscosity and thus cause problems during the lautering and filtration steps.

### SUMMARY OF THE INVENTION

The present invention is based on the surprising finding that high levels of wheat bran or rye bran can be used as a cost-effective adjunct for brewing high quality bottom fermented beer. Bran is a relatively cheap by-product of cereal milling, generated for instance during the production of cereal flour for bread making.

Therefore, in a first object the present invention provides a method for brewing a bottom fermented beer using grist comprising at least 10%, preferably at least 15% and up to 50%, preferably up to 40% (w/w on dry matter basis) of bran, such as wheat bran or rye bran, and further comprising malt, preferably barley malt. Optionally the grist may also comprise one or more brewing adjuncts known in the art. The beers produced according to the method of the present invention have an excellent taste and taste stability during ageing. Moreover, said beers were found to comprise increased levels of health-related phytonutrients such as ferulic acid, silicon, and alkylresorcinols, more particular C19-alkylresorcinols.

### BRIEF DESCRIPTION OF THE DRAWINGS

FIG. 1 shows the result of a sensory analysis (n=8) of the key taste components for two experimental beers resulting from brew 1 (100% malt) and brew 2 (90% malt, 10% rye bran). Bars represent means of the scores and error bars indicate the standard deviation. Bars with a star show a significant difference from the witness value according to the Wilcoxon signed rank test at p<0.05.

FIG. 2 shows the result of a sensory analysis (n=22) of the key taste components for two experimental beers resulting from brew 3 (100% malt) and brew 4 (75% malt, 25% wheat bran). Bars represent means of the scores and error bars indicate the standard deviation. Bars with a star show a significant difference from the witness value according to the Wilcoxon signed rank test at p<0.05.

FIG. 3 shows the result of a sensory analysis (n=6) of experimental beers resulting from brew 3 (100% malt), brew 4 (75% malt, 25% wheat bran) and brew 5 (75% malt, 25% rye bran) after forced ageing for 2 months at 30° C. Beers were ranked from 1 (least aged) to 3 (most aged). Bars represent means of the ranks and error bars indicate the standard deviation. Bars marked with a different letter are significantly different from each other according to Friedman's 1-way ANOVA by ranks test at p<0.05.

FIG. 4 shows the result of a sensory analysis (n=8) of experimental beers resulting from brew 3 (100% malt) and brew 4 (75% malt, 25% wheat bran) after forced ageing for 2 months at 30° C. Beers were scored for degree of ageing with a score ranging from 0 (no perceivable ageing) to 8 (very strongly aged, undrinkable). Bars represent means of the scores and error bars indicate the standard deviation. Bars marked with a different letter are significantly different from each other according to the Wilcoxon signed rank test at p<0.01.

### DETAILED DESCRIPTION OF THE INVENTION

The present invention shows that a grist comprising between 10 and 50% (w/w) of cereal bran, such as wheat bran or rye bran, and further comprising at least 40% (w/w) of barley malt can be used for brewing bottom fermented beers comprising an alcohol content similar to that of traditional bottom fermented beers. Surprisingly, beers produced using the bran-containing grist were judged by a taste panel to have a better taste and a better taste stability during ageing than comparable beers brewed using traditional grist comprising mainly barley malt. At the same time the total raw material cost of the bran based beers was significantly lower than of the traditional beers.

Therefore, in a first object the present invention provides a method for brewing a bottom fermented beer using a grist comprising more than 10% (w/w on a dry matter basis), preferably at least 15% (w/w), more preferably at least 18% (w/w), most preferably at least 20% (w/w), for instance at least 25% (w/w) of bran from cereals such as wheat or rye. Preferably the grist comprises at most 50% (w/w), more preferably at most 40% (w/w), for instance at most 35% (w/w) of cereal bran. The remaining part of the grist comprises malt, such as barley, wheat, or rye malt or a combination thereof, and optionally one or more brewing adjuncts such as unmalted cereal grains, unmalted degermed cereal grains, maize grits, maize flakes, starch, hydrolysed or partially hydrolysed starch, maltose, glucose, molasses, or sucrose. Depending on the amount of bran and brewing adjuncts comprised in the grist, the grist preferably comprises at least 40% (w/w), more preferably at least 50%, for instance more than 60% (w/w) or more than 70% (w/w) of malt. Preferably, the grist comprises at most 90% (w/w) of malt, more preferably at most 85% (w/w), for instance less than 80% (w/w) of malt. In a preferred embodiment more than half of the malt comprised in the grist is barley malt. Preferably, the combined fraction of the said brewing adjuncts is less than 45% (w/w) of the grist, such as less than 35%, 25% or 20% (w/w), for instance less than 15 or 10% (w/w).

Bran typically has a low bulk density, so in order reduce transport and storage costs, the bran is sometimes compressed for instance by means of an extruder or pelletizer. Both low bulk density bran and compressed bran are suitable to be used in the method of the present invention.

It was observed that the use of milled or ground cereal bran having a reduced particle size eased the stirring of the bran-containing mash, particularly in high gravity brewing. The use of milled or ground bran further resulted in a reduction of the retention of wort in the spent grains and in a lower spent grain volume after lautering. Therefore, in a preferred embodiment of the brewing method of the present invention ground or milled cereal bran comprising a fraction of at least 50% (w/w) with a particle size below 0.5 mm is used. Preferably, the bran is milled or ground prior to the mashing of the bran. Said ground or milled bran can be obtained by processing bran using milling equipment such as an impact mill, hammer mill, roller mill, ball mill, pin mill, jet mill or disc mill. Milling or grounding so as to reduce the average particle size of the cereal bran can be performed either on dry or wet bran prior to addition to the grist, or on dry or wet grist after addition of the bran to the grist.

Preferably the bran used in the brewing method of the present invention is obtained by milling cereal grains from which at least part of the outer pericarp was removed by pearling or peeling. The removal of the outer pericarp eliminates most microbial contaminants and mycotoxins that accumulate on the surface of cereal grains and in the outer pericarp, respectively.

In order to avoid excessive beta-glucanase and protease activity during mashing, it is preferred that the bran-containing grist is mashed in at an initial temperature (mashing-in temperature) between 55° C. and 65° C., most preferably between 60° C. and 65° C. In this way, excessive beta-glucanase activity and protease activity is avoided. Furthermore, it may be advantageous to perform the mashing step at a pH between 5.0 and 5.6, most preferably between 5.0 and 5.4. The pH of the mash can be adjusted towards the indicated values by the addition of acids such as for instance but not limited to lactic acid, citric acid, phosphoric acid, malic acid, tartaric acid, or sulfuric acid.

Due to the lower malt content in the bran-containing grist, the endogenous amylase activity is comparatively low. Therefore, it is preferred that in the brewing method of the present invention selected exogenous starch degrading enzymes, such as alpha-amylases and beta-amylases, are added during the mashing step.

Following mashing, the brewing method according to the present invention can proceed in accordance with the brewing procedures known in the art. Therefore, the brewing method of the present invention has the advantage that except for the addition of bran to the mashed grist and the adjustment of the mashing parameters, it does not require any alteration of the traditional brewing processes. Moreover, it was noticed that using the present brewing method the time required for lautering could be reduced.

Given the lower fermentable carbohydrate content of rye or wheat bran as compared to that of malt, the skilled person will understand that the brewing method of the present invention requires a higher amount of said bran-containing grist than is needed to brew a beer with a same alcohol content using a traditional grist, which typically contains 95% (w/w) or more barley malt. Preferably, the dry matter amount of bran-containing grist used in the brewing of a bottom fermented beer according to the present invention is increased by at least one quarter and up to three quarters of the percentage of bran (w/w) comprised in the grist, relative to the dry matter amount required for the brewing of a beer with a same alcohol content using a traditional grist. For instance, when using a grist according to the present invention comprising 24% (w/w) of wheat bran or rye bran, about 6 to 18% (w/w) more grist on a dry weight basis is needed than in the brewing of a comparable beer with the same alcohol content using a grist comprising 95% (w/w) or more barley malt. Although the brewing method of the present invention depends on the use of more grist than for the brewing of comparable traditional beers with a same alcohol content, it nevertheless allows producing beers at a lower raw material cost.

Furthermore, it was observed that the brewing method of the present invention resulted in beers with a relatively high real extract, which typically contributes to the body and the mouth feel of a beer. Indeed sensory analysis using a taste panel indicated that the taste of the beers brewed according to the method of the present invention was preferred over that of a comparable beer with about the same alcohol content made in a brewing process as available in the art. Moreover, it was found that the taste stability during ageing of the beers brewed according to the present invention was better than that of their traditional counterparts.

The method of the present invention can be used in the brewing of beers produced by bottom fermentation of a low gravity wort, by bottom fermentation of diluted wort, or by diluting bottom fermented wort. This group of beers comprises many of the so called low alcohol beers or alcohol free beers and the low calorie or ‘light’ beers. Low alcohol beers typically comprise less than 3.5% (v/v), preferably less than 1.5% (v/v), more preferably less than 0.5% (v/v) alcohol. Low calorie or ‘light’ beers typically contain more than 3.5% (v/v) alcohol but comprise less than 3 g real extract per 100 ml, preferably less than 2.5 g per 100 ml. The method of the present invention can also be used in the brewing of lager beers produced by bottom fermentation, such as Pilsner style beers. Many of these beers comprise between 3.5% and 8% (v/v) alcohol, for instance between 3.5% and 6% (v/v), and between 3.0 and 5.0 g real extract per 100 ml. However, bottom fermented beers comprising more than 8% (v/v) alcohol up to 12% (v/v) and/or more than 5.0 g real extract per 100 ml can also be produced using the method of the present invention.

The beers produced according to the present invention had an increased level of health-related phytonutrients and minerals. Analysis of these beers indicated that they comprised total ferulic acid levels, in particular bound ferulic acid, exceeding 0.5 mg per g of dry matter, silicon levels above 0.7 mg per g of dry matter and/or C19 alkylresorcinols exceeding 50 ng per g dry matter. In as far the applicant is aware this is the first of report of beers comprising such high levels of either total ferulic acid, silicon or C19 alkylresorcinols. Moreover, as indicated in table 9 the analysis of commercially available beers with an alcohol content varying between 5 and 8.6% (v/v) did not reveal comparable levels of the mentioned compounds in such commercial beers. Therefore, in a second object the present invention provides bottom-fermented beers having increased levels of either or all total ferulic acid, silicon and C19 alkylresorcinols. The bottom-fermented beers of the present invention preferably have a silicon content, mainly in the form of orthosilicate, higher than 0.7 mg/g dry matter, such as higher than 0.8 mg/g dry matter, for instance higher than 0.85 mg/g dry matter. Preferably the silicon content in said beers is at most 5 mg/g dry matter, more preferably at most 4 mg/g dry matter, such as less than 3 or 2 mg/g dry matter, for instance less than 1 mg/g dry matter.

The bottom-fermented beers of the present invention preferably have a total ferulic acid content, of which more than 70% is bound via ester or ether linkages, higher than 0.5 mg/g dry matter, such as higher than 0.6 mg/g dry matter, for instance higher than 0.65 mg/g dry matter. Preferably the total ferulic acid content in said beers is at most 10 mg/g dry matter, more preferably at most 5 mg/g dry matter, such as less than 2.5 mg/g dry matter, for instance less than 1 mg/g dry matter.

The bottom-fermented beers of the present invention preferably have a content of C19:0 alkylresorcinol higher than 50 ng/g dry matter, such as higher than 60 ng/g dry matter, preferably higher than 70 ng/g dry matter, such as higher than 80 ng/g dry matter or higher than 90 ng/g dry matter. Preferably the content of C19:0 alkylresorcinol in said beers is at most 1000 ng/g dry matter, more preferably at most 500 ng/g dry matter, such as less than 250 ng/g dry matter, for instance less than 150 ng/g dry matter. Preferably the ratio of C19:0 alkylresorcinol to the sum of C17:0, C19:0, C21:0, C23:0, and C25:0 alkylresorcinols in such bottom-fermented beers is higher than 16% (w/w), such as higher than 18%, preferably higher than 20%, such as higher than 22% or higher than 24%. Preferably the ratio of C19:0 alkylresorcinol to the sum of C17:0, C19:0, C21:0, C23:0, and C25:0 alkylresorcinols in such bottom-fermented beers is at most 50% (w/w), more preferably at most 40% (w/w), such as for instance less than 30% (w/w).

In a more preferred embodiment the present invention provides bottom-fermented beers with a total ferulic acid content higher than 0.5, more preferably higher than 0.6, most preferably higher than 0.65 mg/g dry matter and with a silicon content higher than 0.7, more preferably higher than 0.8, most preferably higher than 0.85. Preferably the silicon content in said beers is at most 5 mg/g dry matter, more preferably at most 4 mg/g dry matter, such as less than 3 or 2 mg/g dry matter, for instance less than 1 mg/g dry matter. Preferably the total ferulic acid content in said beers is at most 10 mg/g dry matter, more preferably at most 5 mg/g dry matter, such as less than 2.5 mg/g dry matter, for instance less than 1 mg/g dry matter.

In another more preferred embodiment the present invention provides bottom-fermented beers with a total ferulic acid content higher than 0.5, more preferably higher than 0.6, most preferably higher than 0.65 mg/g dry matter and wherein the ratio of C19:0 alkylresorcinol to the sum of C17:0, C19:0, C21:0, C23:0, and C25:0 alkylresorcinols is higher than 16% (w/w), preferably higher than 18%, more preferably higher than 20%, most preferably higher than 22%, for instance higher than 24%. Preferably the total ferulic acid content in said beers is at most 10 mg/g dry matter, more preferably at most 5 mg/g dry matter, such as less than 2.5 mg/g dry matter, for instance less than 1 mg/g dry matter. Preferably the ratio of C19:0 alkylresorcinol to the sum of C17:0, C19:0, C21:0, C23:0, and C25:0 alkylresorcinols in such bottom-fermented beers is at most 50% (w/w), more preferably at most 40% (w/w), such as for instance less than 30% (w/w).

In yet another preferred embodiment the present invention provides bottom-fermented beers with a silicon content higher than 0.7, more preferably higher than 0.8, most preferably higher than 0.85 and wherein the ratio of C19:0 alkylresorcinol to the sum of C17:0, C19:0, C21:0, C23:0, and C25:0 alkylresorcinols is higher than 16% (w/w), preferably higher than 18%, more preferably higher than 20%, most preferably higher than 22%, for instance higher than 24%. Preferably the silicon content in said beers is at most 5 mg/g dry matter, more preferably at most 4 mg/g dry matter, such as less than 3 or 2 mg/g dry matter, for instance less than 1 mg/g dry matter. Preferably the ratio of C19:0 alkylresorcinol to the sum of C17:0, C19:0, C21:0, C23:0, and C25:0 alkylresorcinols in such bottom-fermented beers is at most 50% (w/w), more preferably at most 40% (w/w), such as for instance less than 30% (w/w).

In a most preferred embodiment the present invention provides bottom fermented beers having understanding characteristics:
i. a total ferulic acid content higher than 0.5, more preferably higher than 0.6, most preferably higher than 0.65 mg/g dry matter,
ii. a silicon content higher than 0.7, more preferably higher than 0.8, most preferably higher than 0.85 mg/g dry matter and
iii. the ratio of C19:0 alkylresorcinol to the sum of C17:0, C19:0, C21:0, C23:0, and C25:0 alkylresorcinols comprised in said beers is higher than 16% (w/w), preferably higher than 18%, more preferably higher than 20%, most preferably higher than 22%, for instance higher than 24%.

Preferably the total ferulic acid content in said beers is at most 10 mg/g dry matter, more preferably at most 5 mg/g dry matter, such as less than 2.5 mg/g dry matter, for instance less than 1 mg/g dry matter. Preferably the silicon content in said beers is at most 5 mg/g dry matter, more preferably at most 4 mg/g dry matter, such as less than 3 or 2 mg/g dry matter, for instance less than 1 mg/g dry matter. Preferably the ratio of C19:0 alkylresorcinol to the sum of C17:0, C19:0, C21:0, C23:0, and C25:0 alkylresorcinols in such bottom-fermented beers is at most 50% (w/w), more preferably at most 40% (w/w), such as for instance less than 30% (w/w).

The beers according to the second object of the present invention can be low alcohol beers or low calorie beers. Low alcohol beers typically comprise less than 3.5% (v/v), preferably less than 1.5% (v/v), more preferably less than 0.5% (v/v) alcohol. Low calorie or ‘light’ beers typically contain more than 3.5% (v/v) alcohol but comprise less than 3 g real extract per 100 ml, preferably less than 2.5 g per 100 ml. The beers according to the second object of the present invention can also be more traditional bottom fermented beers, such as for instance lager beers of the Pilsner style. Many of these beers comprise between 3.5% and 8% (v/v) alcohol, for instance between 3.5% and 6% (v/v), and between 3.0 and 5.0 g real extract per 100 ml. However, bottom fermented beers according to the second object of the present invention may comprise more than 8% (v/v) alcohol up to 12% (v/v) and/or more than 5.0 g real extract per 100 ml.

For the purpose of completeness an overview of the steps involved in a typical brewing process is given below. The skilled person understands that according to the beer style some alternative steps may occur.
“Malting” involves the germination of cereal grains by steeping and soaking in water to allow sprouting. During sprouting several types of enzymes are produced, including those that catalyze the conversion of starch into simple, fermentable sugars. The germinated grains are then dried and roasted (a process called “kilning”) to kill the sprouts and to provide the grain with roasted grain flavors and color. Grains treated this way are called malted grains or simply “malt”. The malt is milled to crack the grains and to remove the sprouts, which allows the content of the malted grains to be better exposed to water during mashing and boiling.
“Mashing” involves the mixing of grist, including milled malted grains, with water, to obtain the so-called “mash”. The mash is heated to reach more optimal temperatures for the activity of malt enzymes or exogenously added enzymes. Mashing is typically executed at temperatures ranging from about 45° C. to about 75° C. During mashing oligosaccharides, disaccharides and monosaccharides are generated by enzymatic breakdown of complex carbohydrates, mainly starch. Such simple sugars form a carbon and energy source for the microorganisms during fermentation.
“Lautering” involves the separation of the mash into a liquid extract, called “wort”, and the insoluble materials, called “spent grains”. Lautering is typically executed at a temperature of about 75° C. to about 100° C.
“Wort boiling” involves heating of the wort at water boiling temperature. The key purposes of boiling is to (i) kill microorganisms in order to eliminate competition for the fermentation microorganisms, (ii) coagulate and to precipitate proteins or other solids that may cause turbidity of the beer, and (iii) extract and chemically modify bitter, aromatic and flavoring compounds from herbs, such as hops, or herb extracts added before or during wort boiling.
“Cooling and inoculation” involves the cooling of the boiled wort to a temperature that is optimal for the fermentation microorganisms. These fermentation microorganisms, for example brewer's yeast (Saccharomyces cerevisiae), are either added on purpose to the wort (called “pitching”) or added by spontaneous inoculation.
“Fermentation” involves the incubation of the wort inoculated with the fermentation microorganisms. During fermentation the simple sugars are converted by these microorganisms into carbon dioxide, ethanol and numerous other by-products.
“Post-fermentation processing” are the steps following primary fermentation up to the production and packaging of a finished beer. Depending on the type of beer and the method used, such post-fermentation processing may involve one or more of the following: the beer may be maturated to further develop desirable flavors and aromas and/or reduce the levels of undesirable flavors and aromas; the beer can be filtered to remove the residual yeast and other turbidity-causing materials; the beer can be treated with an absorbent to remove specific compounds such as hydrophilic proteins or polyphenols; the beer can be subjected to additional fermentation steps (with or without addition of an extra carbon source); herbs or herb extracts can be added; fruits or fruit extracts can be added; the beer can be carbonated to increase the bubbly aspect of beer; the beer can be pasteurized or microfiltrated to enhance microbial stability; and the beer can be packaged by e.g. bottling, canning or kegging.

In the present invention, the term “beer” refers to any fermented beverage made from cereal grains, preferably barley, wheat, triticale, oat, rye, maize, sorghum, millet or rice, as well as milled cereals or malt produced from such cereal grains, with or without addition of parts or extracts from aromatic plants such as hops, coriander, juniper, bay, rosemary, ginger, mint, licorice, yarrow, anis, or citrus, and with or without addition of fruits or fruit extracts. The term beer as used herein is meant to include, without limitation, ale, strong ale, mid ale, bitter ale, pale ale, sour ale, stout, porter, lager, malt liquor, barley wine, happoushu, bock, doppelbock, Kölsch beer, Münchener beer, Dortmunder beer, Düsseldorfer alt beer, Pilsener beer, märzen beer, German weizenbier, Berliner weisse, Saisons beer, abbey beer, Trappist beer, gueuze, Iambic beer, fruit beer, Belgian white beer, high alcohol beer, low alcohol beer, non-alcoholic beer, low calorie beer, light beer, and the like.

In the present invention, the term “bottom fermented beer” refers to a beer which has undergone a fermentation by micro-organisms comprising at a least a species of the genus Saccharomyces, followed by a maturation (also called “lagering”) for at least 1 day at a temperature below 10° C., such as between 0° C. and 4° C.

In the present invention, the term “clear” refers to an attribute of beer characterized by having an EBC (EBC=European Brewery Convention) turbidity value below 40.

The term “real extract”, in the context of this invention, is defined as the grams of dry matter per 100 ml beer obtained after evaporation of the liquid and gaseous fraction (water, alcohol, dissolved gasses) of the beer.

The term “mouthfeel”, is used to depict the carbonation, fullness and after-feel of a beer where these descriptors are used to describe the textural attributes that are responsible for producing characteristic tactile sensations on the surface of the oral cavity.

The term “taste”, is defined as the perceived impression of aromas and flavour upon contact of the beer with the oral cavity.

The term “taste stability”, is used to describe the difference in taste between a freshly produced finished beer and the same beer after storing for a prolonged period of time usually at ambient temperature. The term “taste stability” also refers to the level of decrease upon aging of favorably perceived taste components such as the bitter hop-derived iso-alfa-acids, and the increase upon aging of unfavorably perceived taste components.

The term “grist” in the context of the present invention means the group of products comprising milled malted grains, cereal bran, preferably wheat bran or rye bran and adjuncts, which are mixed with water during the mashing step of the beer brewing process.

The term “adjunct” in the context of the present invention means carbohydrate-rich ingredients, other than milled malted grains, that are mixed with water during the mashing step of the beer brewing process.

The term “bran” in the context of the present invention, means a milled fraction derived from cereal grains that is enriched in any or all of the tissues to be selected from aleurone, pericarp, seed coat, sepals, and petals, as compared to the corresponding intact cereal grain. Examples of such milling fractions include, but are not limited to, bran, shorts, peeling fractions, pearling fractions, red dog, middlings, mill run, and tailings.

The term “Alkylresorcinols” in the present invention means phenolic lipids with an odd-numbered alkyl chain at position 5 of the 1,3-dihydroxybenzene ring. In cereals alkylresorcinols exist mainly with alkyl chains C15:0, C17:0, C19:0, C21:0, C23:0 and C25:0. C19:0 alkylresorcinol is an alkylresorcinol of which the alkyl chain at position 5 of the 1,3-dihydroxybenzene ring has 19 carbon atoms and consists only of single carbon-carbon bonds.

The term “real extract”, in the context of this invention, is defined as the grams of dry matter per 100 ml beer obtained after evaporation of the liquid and gaseous fraction (water, alcohol, dissolved gasses) of the beer.

The present invention may, if necessary for the quality control of the production method, include the measurement and/or the analysis of the concentration of total ferulic acid, silicon, and C15:0, C17:0, C19:0, C21:0, C23:0 and C25:0 alkylresorcinols in brewing liquids and beer at one or more steps of the brewing process. Said method comprises the analytical techniques described in Example 2 of the present invention.

The invention is further illustrated by way of the non-limiting illustrative embodiments described below.

### Example 1

### Clear Bottom Fermented Beer Made Using Bran as Adjunct

### Materials.

Pilsner malt was purchased from Mouterij Albert (Puurs Belgium). Wheat bran and rye bran were obtained from Dossche Mills & Bakery (Deinze, Belgium) and Molens Goethals (Gent, Belgium), respectively. The carbohydrate composition of the bran fractions shown in Table 1 was determined by the method of Courtin et al. 2000, whereby the carbohydrates were first hydrolyzed to monosaccharides by acid hydrolysis, and the resulting monosaccharides detected as alditol acetates by gas chromatography. Termamyl 120 L (a thermostable alpha-amylase preparation), Attenuzyme (an amyloglucosidase preparation), and Promozyme (a pullulanase preparation) were purchased from Novozymes (Bagsvaerd, Denmark).

### Analytical Techniques.

Alcohol content in beer samples was measured by near infrared spectroscopy (Alcolyzer Plus, from Anton Paar), real extract was measured by an oscillating U-tube density meter (Alcolyzer Plus, from Anton Paar), all according to standard methods outlined in Analytica EBC (1998).

### Beer Brewing.

Beers were made on 50 liter scale according to the following process. The composition of the mash and the mashing temperature scheme are specified below. Brewing water consisted of water purified by reverse osmosis to which Ca²⁺ was added to a final concentration of 40 mg/l. The pH of the mash was controlled at 5.6 using lactic acid. Lautering was performed over a lauter tun at a temperature of 78° C. during 60 minutes. The filtered worts were boiled during 60 minutes. The worts were hopped by addition of isomerized hop acid extract (20% iso-acids w/v, from Botanix Ltd., Paddock Wood, England) to a final concentration of 25 mg/l iso—acids at 5 minutes before the end of boiling. Zn²⁺ was added to a final concentration of 0.2 mg/l at 5 minutes before the end of boiling. The boiled wort were clarified using a whirlpool. Cooled clarified worts were pitched with yeast (Saflager 3470, from Lesaffre) at 10⁷ cells/ml, followed by fermentation during 8 days at 12° C. and lagering during 7 days at 0° C. The bitterness of the beers was adjusted by addition of isomerized hop acid extract (20% iso-alpha-acids w/v, Botanix Ltd., Paddock Wood, England) at a final concentration of 25 mg/l iso-alpha-acids. The beers were filtered over kieselguhr/cellulose sheets (1 μm) and finally bottled and sealed in brown standard 25 cl bottles (O₂-content<80 ppb) using an isobaric filling machine with double pre-evacuation (America monobloc, from Cimec, Italy).

### Beer Aging.

Freshly brewed beers were stored for one month at 0° C. where after they were transferred to a dark room at 30° C. for 2 months.

### Sensory Analyses.

Sensory analyses of beers were conducted in a quiet room by a trained panel. All samples were coded by a randomly generated double digit number and the order by which the samples to the panelists were presented was random. The sensory properties sweetness, sourness, bitterness, astringency and mouthfeel (fullness) were given a score on a scale from 0 (not detectable) to 8 (very strong). The scores were analysed statistically by the non-parametric Wilcoxon signed rank test in case two beers were compared, or by the non-parametric Friedman's 1-way ANOVA by ranks test in case more than two beers were compared. The panelists were also asked to indicate the preference for one of the two beers. The preference ranking data on comparison of two beers were analysed statistically by the McNemar test. All statistical analysis was performed with the Analyse-it software, version 1.73. To test for taste stability of beers, the panelists were asked to give ageing scores (adapted from the procedure of Araki et al. (1999), 0: fresh; 2: very weakly aged; 4: moderately aged; 6: strongly aged; 8: very strongly aged, undrinkable), and rank the aged beer samples according to their degree of ageing. The ageing scores were analysed statistically by the non-parametric Wilcoxon signed rank test in case two beers were compared, or by the non-parametric Friedman 1-way ANOVA by ranks test in case more than two beers were compared. The ageing ranking data were analysed statistically by Friedman's 1-way ANOVA by ranks test in case more than two beers were compared, and by the McNemar test in case two beers were compared. All statistical analysis was performed with the Analyse-it software, version 1.73.

### Results

Three experimental beers, brew 3, 4 and 5, were brewed with a mash composition specified in Table 5. Brew 3 was the witness beer of which the grist was composed of 100% pilsner malt. The grist of brew 4 comprised 75% pilsner malt and 25% wheat bran, and the total amount of grist per volume of the mash was increased by 12% compared to the witness beer. The grist of brew 5 was identical to that of brew 4 except that rye bran was used instead of wheat bran. The beers of brew 3, 4 and 5 had about the same alcohol content but the real extract value of the bran-containing beers of brew 4 and 5 beer were 23% and 30% higher that that of the witness beer, respectively (Table 6). Sensory evaluation of the beers indicated that both beers of brew 4 and 5 were significantly preferred over the witness beer (Table 7, Table 8). Sensory characterisation of the main taste components of beers 3 and 4 revealed that beer 4 was significantly less astringent than the witness beer 3 (FIG. 2). Hence, reduced astringency may be one of the reasons why the bran-containing beers are preferred to the all malt witness beer.

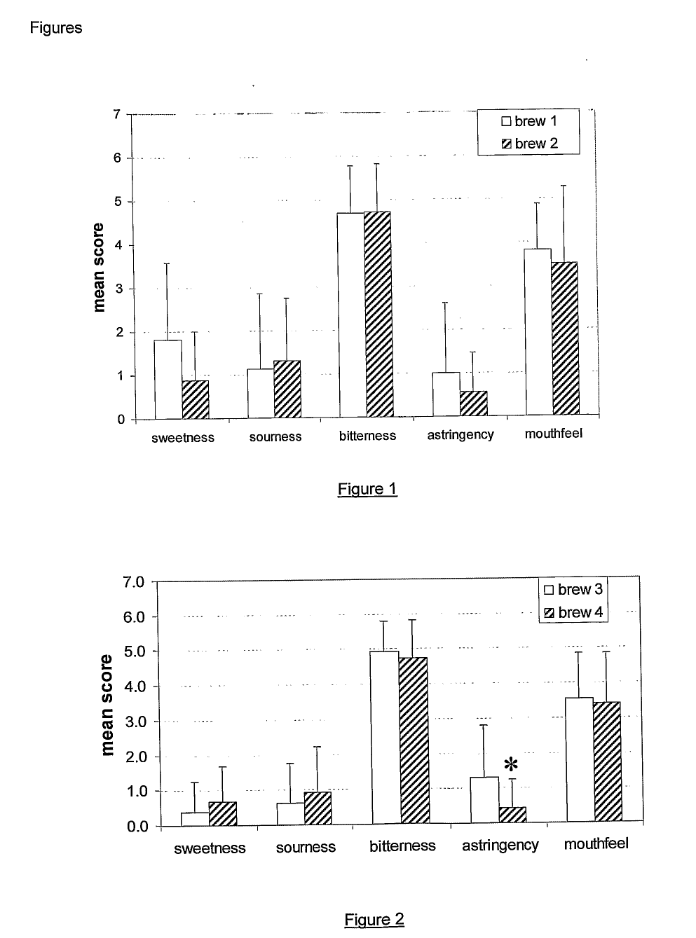

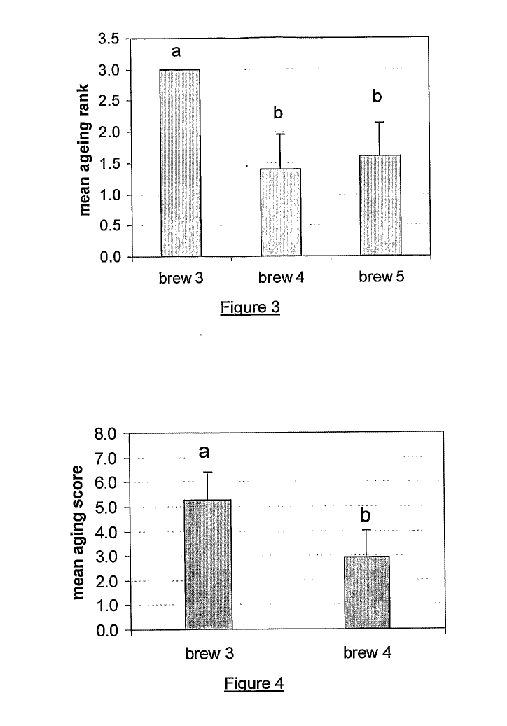

Beers 3, 4 and 5 were subjected to ageing for a period of 2 months at 30° C. In a first sensory evaluation, beers 3, 4 and 5 were ranked for degree of ageing. This evaluation indicated that both bran-containing beers 4 and 5 were ranked significantly less aged relative to the witness beer 3 (FIG. 3). In a second and independent sensory evaluation involving beers 3 and 4, all eight panelists consistently ranked beer 4 as being less aged than beer 3. Moreover, scoring for degree of ageing confirmed that beer 4 showed significantly less ageing-related off-taste compared to beer 3 (FIG. 4). Hence, the beers brewed by substituting part of the malt by cereal bran not only were preferred in their fresh state, but also showed a significant improvement of the taste stability.

### Example 2

### Analysis of Bottom Fermented Beer Made Using Bran as Adjunct

### Materials.

Beers 3 and 4 were made from brews 3 and 4 as described in Example 1. Commercial beers were purchased in a local store.

### Analysis of Total and Free Ferulic Acid.

Beer samples (90 ml) were sonicated in a sonication bath and subsequently lyophilised. Total ferulic acid (sum of bound and free ferulic acid) content was determined on 10-50 mg samples suspended in sodium hydroxide (5 ml; 2 M, oxygen-free). The headspace over the solution was purged with nitrogen and hydrolysis of bound ferulic acid was conducted for 18 h at room temperature. o-Coumaric acid (100 μl, 50 mg/100 ml) was added as an internal standard and the solution was acidified with hydrochloric acid (4 ml; 4 M). Then, the solution was extracted three times with ethyl acetate (3 ml, respectively), and the organic phases were combined and dried with nitrogen. The residue was dissolved in methanol (5 ml) and filtered (0.45 μm pore size filter) prior to HPLC analysis. Free ferulic acid content was determined on 200 mg sample suspended in hydrochloric acid (2 ml; 0.1 M). o-Coumaric acid (50 μl, 50 mg/100 ml) was added as an internal standard. Then, the solution was extracted three times with ethyl acetate (3 ml, respectively), and the organic phases were combined and dried with nitrogen. The residue was dissolved in methanol (2.5 ml) and filtered (0.45 μm pore size filter) prior to HPLC analysis. A Kontron Kroma System 2000 HPLC system (Biotek) with a 522 pump module, a 535 UV detector and a Superspher 60 RP8 column (125×4.0 mm; Merck) with an ODS2 precolumn (25×4.0 mm; Waters) was used. The injection volume was 100 μl, the flow rate was 0.8 ml/min and detection was made by measurement of the absorbance at 310 nm. A solvent (water:acetonitrile:acetic acid; 75:25:0.04 v/v/v) was applied isocratically. Quantization was based on the peak areas at 310 nm and calibration curves were obtained by injection of standard solutions with different molar ratios of ferulic acid and internal standard (1:5, 1:1, 5:1).

### Analysis of Silicon.

Total silicon analysis was carried out on liquid beer samples by inductively coupled plasma optical emission spectrometry (ICP-OES; Jobin-Yvon Horiba JY2000-2; Longjumeau, France) at 251.611 nm. The instrument was equipped with a concentric nebuliser and cyclonic spray chamber and samples were applied at a flow rate of 1 ml/min. Peak profiles were used as described in Burden et al (1995; 1998), using a window size of 0.1 nm (0.05 nm either side of the peak) with 21 increments per profile and an integration time of 0.5 seconds per increment. Samples were run with individual sample-based standards and pooled sample-based standards. Individual sample-based standards were prepared by spiking 20 ppm Si from a 9680 ppm Si standard (Aldrich Chemical Co, UK) in to an aliquot of the individual samples. Pooled sample-based standards were prepared by first pooling 3 ml of each sample and then spiking aliquots of the pooled sample with Si (0, 10, 20 and 40 ppm) from the 9680 ppm standard. Although values using individual sample-based standards are reported, there was good agreement with values obtained using pooled sample-based standards. All samples were analyzed in triplicates. To express data on dry matter basis, silicon content (in mg/100 ml) was divided by real extract (g/100 ml, determined as described in Example 1).

### Analysis of Alkylresorcinols.

Samples for alkylresorcinol (AR) analysis were prepared as follows:
1) Place beer samples (20 ml) in a 50 mL glass tube, degas by sonication, and freeze dry in a lyophilisator.
2) Place 100 mg of a freeze-dried beer sample in a 20 mL glass tube with a tight screw cap.
3) Add 0.90 μg synthetic C20:0 AR (concentration 10.3 μg/mL) as internal standard (Reseachem Life Science, Burgdorf, Switerland).
4) Add 12 mL ethyl acetate and extract sample under continuous shaking on a rolling mixer for 24 h.
5) Evaporate sample extracts to dryness by using a vacuum centrifuge.
6) Re-dissolve sample in 1 mL ethyl acetate and filter the extract through 0.45 μm GHP Acrodisc® filters (VWR, Darmstadt, Germany) connected to 1 mL Omnifix®-F syringes (Braun, Germany) into new tubes
7) Evaporate to dryness by using a vacuum centrifuge and silylate with 200 μl QSM (pyridine:hexamethyldisilazan:trimethylchlorosilane 9:3:1) at room temperature for 30 min.
8) Transfer the silylated sample to a gas chromatography vial (GC-vial) and inject 1.0 μL into the Gas Chromatography Electron Ionisation Mass Spectrometry instrument (GC-EIMS).

The standards for quantification were prepared as follows:
1) Prepare an AR standard mixture by dissolving synthetic AR (Reseachem Life Science, Burgdorf, Switerland) in chloroform at the following concentrations: 0.484 μg/mL for C17:0 AR, 0.376 μg/mL for C19:0 AR, 0.484 μg/mL for C21:0 AR, 0.391 μg/mL for C23:0 AR, 0.404 μg/mL for C25:0 AR.
2) Place 0, 1, 5, 10, 30, 50, 100, 500 μl AR standard mixture in 10 mL test tubes and add 0.90 μg AR C20:0 (concentration 10.3 μg/mL).
3) Evaporate to dryness in a vacuum centrifuge and silylate with 200 μl QSM (pyridine: hexamethyldisilazan:trimethylchlorosilane 9:3:1) at room temperature for 30 min.
4) Transfer the silylated sample to a GC-vial and inject 1.0 μL into the GC-ELMS.

Samples and standards were analysed on a gas chromatograph coupled to an electron ionisation mass spectrometry detector, which was set at the following conditions:
Inlet temperature: 300° C.
Transfer-line temperature: 310° C.
Ion source temperature: 250° C.
Temperature programme: 200° C. (0 min), 280° C. (11.4 min), 300° C. (13.4 min), 300° C. (18.4 min)
Carrier gas: Helium, constant flow at 1.0 mL/min (approx. 30 cm/s linear velocity)
Ionisation energy: 70 eV
Column: HP-5 column (15 m×0.25 mm×0.25 μm; Thermo Fischer, USA) or equivalent.
Samples and standards were run in full scan mode (detecting m/z 50-650).
Peak identity was confirmed by extracting the base ion (m/z 268, which is common to all AR homologues) and respective specific molecular ions (m/z 492 for C17:0 AR, m/z 520 for C19:0 AR, m/z 548 for C21:0 AR, m/z 576 for C23:0 AR, and m/z 604 for C25:0 AR).

Samples were analysed in quadruplicates. Total alkylresorcinols was determined as the sum of C17:0 AR, C19:0 AR, C21:0 AR, C23:0 AR, and C25:0 AR.

### Results

The use of bran during the beer brewing process can increase the content in beneficial phytonutrients that are known to be present at high concentrations in bran tissues. A first example is ferulic acid, a hydroxycinnamic acid with potent antioxidant properties (Kikuzaki et al. 2002) and antitumour activity (Kampa et al. 2004; Lee, 2005). A second example are alkylresorcinols, bran-specific compounds which provide antioxidant protection when present in biological membranes (Kozubek and Nienartowich 1995) and which inhibit LDL oxidation in vitro (Parikka et al. 2006). A third example is orthosilicate, a mineral that is several-fold concentrated in bran tissues versus endosperm tissues. Beer is one of the main sources of dietary orthosilicate (Powell et al. 2005). Silicate plays an important role in bone health (Schwarz and Milne 1972; Jugdaohsingh et al. 2006) and in prevention of Alzheimer's disease (Gonzalez-Munoz et al 2008a, 2008b). Experiments performed on a mice model for aluminium-induced Alzheimer's disease have demonstrated the protective effects of orthosilicate present in beer (Gonzalez-Munoz et al 2008a, 2008b).

The beer of brew 3 of Example 1, made without bran, and the beer of brew 4 of Example 1, made with wheat bran addition to the grist, were analysed for their content of total ferulic acid, free ferulic acid, silicon (as a measure for orthosilicate), and C17:0, C19:0, C21:0, C23:0, and C25:0 alkylresorcinols. The content of total ferulic acid, silicon, and C19:0 alkylresorcinol was markedly higher for the wheat-bran based beer of brew 4 than for the witness all-malt beer of brew 3 and any of a series of commercial beers, including two beers made with unmalted wheat (the Belgian Witbier, Hoegaarden®) or wheat malt (the German Weizenbier, Erdinger Weissbier®) (Table 9). The ratio of C19:0 alkylresorcinol over the sum of C17:0, C19:0, C21:0, C23:0, and C25:0 alkylresorcinols was 25.1% for the beer of brew 4, whereas it was lower than 14% for all other beers analysed (Table 9).

### Example 3

### Effect of pH on Bottom Fermented Beers Made Using Bran as Adjunct

Two beers are prepared with addition of wheat bran to the grist as described for brew 4 in Example 1. One of the beers is made with a pH of 5.6 during the mashing step, the other one is made with a pH of 5.2, using lactic acid as the acidulating agent. Analysis shows a reduction of the presence of, amongst others, lipoxygenase related off-taste compounds in the beer made at pH 5.2 as compared to that made at pH 5.6.

TABLE 1
Carbohydrate composition (expressed as % w/w monosaccharides obtained
after acid hydrolysis on dry matter basis) of the wheat bran and rye bran
factions used in the brewing experiments described in Example 1. The
glucose mainly reflects starch content and does not take into account
cellulose content, which does not hydrolyse by the acid hydrolysis
method used.

| Monosaccharide (as % | | |
|---|---|---|
| dm after acid hydrolysis) | Wheat bran | Rye bran |
| L-arabinose | 8.5% | 8.2% |
| D-xylose | 14.2% | 13.9% |
| D-mannose | 0.4% | 0.7% |
| D-galactose | 1.4% | 1.3% |
| D-glucose | 32.8% | 37.9% |

TABLE 2
Composition of the mash of brews 1 and 2. The mashing
temperature scheme was 63° C. (45 minutes), 72° C.
(45 minutes), 78° C. (1 minute).

| | Brewing and | | | |
|---|---|---|---|---|
| | sparging | Pilsner | Rye bran | Termamyl |
| Brew code | water (liter) | malt (kg) | (kg) | (ml) |
| brew 1 | 50 | 10 | 0 | 7.5 |
| brew 2 | 50 | 9 | 1 | 7.5 |

TABLE 3
Characterisation of the beers resulting from brews 1 and 2.

| | alcohol | real extract |
|---|---|---|
| Beer code | (% v/v) | (g/100 ml) |
| beer brew 1 | 5.1 | 3.99 |
| beer brew 2 | 5.1 | 4.23 |

TABLE 4
Sensory evaluation of the preference of beers resulting from brews
1 and 2.

| | | Panelists | |
|---|---|---|---|
| | | indicating | |
| Brew code | n | preference | p-value |
| beer brew 1 | 10 | 7 | 0.21 |
| beer brew 2 | 10 | 3 | |

TABLE 5
Composition of the mash of brews 3, 4 and 5. The mashing temperature
scheme was 63° C. (60 minutes), 72° C. (30 minutes), 78° C. (1 minute).

| | Brewing and | | | | | |
|---|---|---|---|---|---|---|
| | sparging | Pilsner | wheat | Rye bran | | |
| Brew code | water (liter) | malt (kg) | bran (kg) | (kg) | Attenuzyme (ml) | Promozyme (ml) |
| brew 3 | 50 | 10 | 0 | 0 | 25 | 25 |
| brew 4 | 50 | 8.4 | 2.8 | 0 | 25 | 25 |
| brew 5 | 50 | 8.4 | 0 | 2.8 | 25 | 25 |

TABLE 6
Characterisation of the beers resulting from brews 3, 4 and 5.

| | alcohol | real extract |
|---|---|---|
| Beer code | (% v/v) | (g/100 ml) |
| beer brew 3 | 5.3 | 3.2 |
| beer brew 4 | 5.5 | 3.9 |
| beer brew 5 | 5.3 | 4.2 |

TABLE 7
Sensory evaluation of the preference of beers resulting from brews
3 and 4.

| | | Panelists | |
|---|---|---|---|
| | | indicating | |
| Brew code | n | preference | p-value |
| beer brew 3 | 22 | 5 | 0.02 |
| beer brew 4 | 22 | 17 | |

TABLE 8
Sensory evaluation of the preference of beers resulting from brews
3 and 5.

| | | Panelists | |
|---|---|---|---|
| | | indicating | |
| Brew code | n | preference | p-value |
| beer brew 3 | 6 | 0 | 0.03 |
| beer brew 5 | 6 | 6 | |

TABLE 9
Analysis of minerals and phytonutrients in beers resulting from brews 3 and 4, and from a series of
commercial beers. Total ferulic acid, free ferulic acid, silicon, and C19:0 alkylresorcinols are
expressed per gram dry matter of the beer. Silicon is also expressed as mg per 100 ml of beer.

| | | | | | | Real |
|---|---|---|---|---|---|---|
| Experimental beer or | | | | Fermentation | Alcohol | extract |
| commercial beer brand | Brewery | Country | Beer style | type | (% v/v) | (g/100 ml) |
| Beer of Brew 3 | KaHo St-Lieven | Belgium | Pilsner | Bottom | 5.3 | 3.2 |
| Beer of Brew 4 | KaHo St-Lieven | Belgium | Pilsner | Bottom | 5.5 | 3.9 |
| Maes ® | Alken-Maes | Belgium | Pilsner | Bottom | 4.9 | 3.4 |
| Stella Artois ® | Inbev Belgium | Belgium | Pilsner | Bottom | 5.2 | 3.9 |
| Budweiser ® | Anheuser-Busch | USA | Pilsner | Bottom | 4.9 | 3.5 |
| Miller High Life ® | Miller Brewing Co. | USA | Pilsner | Bottom | 4.6 | 3.8 |
| Carlsberg Beer ® | Carlsberg Breweries | Denmark | Pilsner | Bottom | 5.5 | 4.1 |
| Duvel ® | Moortgat | Belgium | Blond Strong Ale | Bottom | 8.6 | 4.0 |
| Hoegaarden ® | Hoegaarden | Belgium | Belgian Witbier | Top | 4.9 | 4.6 |
| Erdinger Weissbier ® | Erdinger Weissbrau | Germany | German Weizenbeer | Top | 5.5 | 4.6 |

| | Total | Free | | | | Alkylresorcinol |
|---|---|---|---|---|---|---|
| | ferulic | Ferulic | Silicon | | Alkylresorcinol | C19:0 (% |
| Experimental beer or | acid (mg/g | acid (mg/g | (mg/g | Silicon | C19:0 | total |
| commercial beer brand | DM) | DM) | DM) | (mg/100 ml) | (ng/g DM) | alkylresorcinols) |
| Beer of Brew 3 | 0.41 | <0.1 | 0.59 | 1.89 | 13 | 6.4% |
| Beer of Brew 4 | 0.67 | <0.1 | 0.87 | 3.39 | 92 | 25.1% |
| Maes ® | 0.37 | <0.1 | 0.59 | 2.00 | 15 | 7.5% |
| Stella Artois ® | 0.36 | <0.1 | 0.69 | 2.69 | 46 | 13.8% |
| Budweiser ® | 0.25 | <0.1 | 0.54 | 1.90 | 14 | 6.6% |
| Miller High Life ® | 0.32 | <0.1 | 0.42 | 1.60 | 10 | 3.4% |
| Carlsberg Beer ® | 0.31 | <0.1 | N.D. | N.D. | 31 | 8.6% |
| Duvel ® | 0.27 | <0.1 | 0.64 | 2.54 | 35 | 9.5% |
| Hoegaarden ® | 0.31 | <0.1 | 0.55 | 2.51 | 17 | 8.0% |
| Erdinger Weissbier ® | 0.32 | <0.1 | 0.44 | 2.03 | 10 | 6.5% |

N.D. = not determined

### REFERENCES

Araki S., Kimura T., Shimizu C., Furusho S., Takashio M., Shinotsuka K. (1999) Journal of the American Society of Brewing Chemists, 57: 34-37.
Burden, T. J. Powell, J. J. Taylor, P. D. and Thompson, R. P. H. (1995) Optical accuracy, precision and sensitivity of inductively coupled plasma optical emission spectrometry: Bioanalysis of aluminium. J Anal Atom Spectrom. 10:259-266.
Burden, T. J., Whitehead, M. W., Thompson, R. P. H., and Powell, J. J. (1998) Preparation of urine samples for trace metal determination: a study with aluminium analysis by inductively coupled plasma optical emission spectrometry. Ann Clin Biochem. 35:245-253.
Byrn, M. L. (1873) The complete practical brewer. Published by Henry Carey Baird.
Coppinger, J. (1815) The American practical brewer and tanner. Reprint Edition 2007 published by Beerbooks.com, Cleveland Ohio, ISBN-13: 978-0-9662084-9-8.
Courtin, C. M., Van den Broeck, H. and Delcour, J. A. (2000). Determination of reducing end sugar residues in oligo- and polysaccharides by gas liquid chromatography. Journal of Chromatography A, 866, 97-104.
González-Muñoz M J, P\tilde{e}na A, Meseguer I. (2008a) Role of beer as a possible protective factor in preventing Alzheimer's disease. Food Chem. Toxicol. 46:49-56.
Gonzalez-Muñoz M J, Meseguer I, Sanchez-Reus M I, Schultz A, Olivero R, Benedi J, Sánchez-Muniz F J. (2008b) Beer consumption reduces cerebral oxidation caused by aluminum toxicity by normalizing gene expression of tumor necrotic factor alpha and several antioxidant enzymes. Food Chem. Toxicol. 46:1111-1118.
Jugdaohsingh R, O'Connell M A, Sripanyakorn S, Powell J J (2006) Moderate alcohol consumption and increased bone mineral density: potential ethanol and non-ethanol mechanisms. Proc. Nutr. Soc. 65:291-310.
Kampa M, Alexaki V I, Notas G, Nifli A P, Nistikaki A, Hatzoglou A, Bakogeorgou E, Kouimtzoglou E, Blekas G, Boskou D, Gravanis A, Castanas E (2004) Antiproliferative and apoptotic effects of selective phenolic acids on T47D human breast cancer cells: potential mechanisms of action. Breast Cancer Res. 6:R63-74.
Kikuzaki, H., Hisamoto, M., Hirose, K., Akiyama, K. and Taniguchi, H. (2002) Antioxidant properties of ferulic acid and its related compounds. J. Agric. Food Chem. 50: 2161-2168.
Kozubek A, Nienartowich B. (1995) Cereal grain resorcinolic lipids inhibit H₂O₂-induced peroxidation of biological membranes. Acta Biochim Pol. 1995; 42:309-15
Lee Y S (2005) Role of NADPH oxidase-mediated generation of reactive oxygen species in the mechanism of apoptosis induced by phenolic acids in HepG2 human hepatoma cells. Arch. Pharm. Res. 28: 1183-1189.
Powell J J, McNaughton S A, Jugdaohsingh R, Anderson S H, Dear J, Khot F, Mowatt L, Gleason K L, Sykes M, Thompson R P, Bolton-Smith C, Hodson M J. (2005) A provisional database for the silicon content of foods in the United Kingdom. Br. J. Nutr. 94:804-812.
Schwarz K, Milne D B (1972) Growth promoting effects of silicon in rats. Nature. 239:333-334.
Szwajgier D, Wasko A, Zapp J, and Targonski Z (2007) An attempt to identify the low molecular feruloylated oligosaccharides in beer. J. Inst. Brew. 113: 185-195.
Washington, G. (1757) George Washington. “To Make Small Beer.” From his 1757 notebook. George Washington Papers. Manuscripts and Archives Division. The New York Public Library.
Yuan X, Wang J, and Yao H (2005) Antioxidant activity of feruloylated oligosaccharides from wheat bran. Food Chem. 90: 759-764.
Parikka K, Rowland I R, Welch R W, Wähälä K. (2006) In Vitro Antioxidant Activity and Antigenotoxicity of 5-n-Alkylresorcinols. J Agric Food Chem. 54:1646-50.

1. A method for brewing a bottom fermented beer comprising the mashing of a grist, wherein said grist comprises between 15 and 50% (w/w on dry matter basis) of cereal derived bran and between 40 and 85% (w/w on dry matter basis) of malt.

2. The method according to claim 1 wherein the grist comprises between 20 and 40% (w/w) of cereal derived bran.

3. The method according to claim 1 wherein the grist comprises between 20 and 30% (w/w) of cereal derived bran.

4. The method according to any of the claims 1 to 3 wherein the cereal derived bran is wheat bran or rye bran.

5. The method according to claims 1 to 4 wherein malt is barley, wheat or rye malt.

6. The method according to any of the claims 1 to 5 wherein the cereal derived bran is obtained by milling cereal grains from which the outer pericarp layer is removed by peeling or pearling.

7. The method according any of the claims 1 to 6 wherein the bran is milled or ground prior to its addition to the mash.

8. The method according to claim 7 wherein said milled or ground bran comprises a fraction of at least 50% (w/w) having a particle size lower than 0.5 mm.

9. The method according to any of the claims 1 to 8 wherein the mashing-in temperature is between 60° and 65° C.

10. The method according to any of the claims 1 to 9 wherein the pH of the mash is adjusted to between 5.0 and 5.6.

11. The method according to any of the claims 1 to 10 wherein starch degrading enzymes are added to the mash.

12. A bottom fermented beer wherein (i) said beer comprises more than 0.5 and up to 5 mg total ferulic acid per gram dry matter, or (ii) wherein said beer comprises more than 0.6 and up to 5 mg total ferulic acid per gram dry matter, or (iii) wherein the ratio of C19:0 alkylresorcinol to the sum of C17:0, C19:0, C21:0, C23:0 and C25:0 alkylresorcinols comprised in said beer is at least 16% and up to 50% (w/w).

13. A bottom-fermented beer according to claim 12 comprising more than 0.6 and up to 5 mg total ferulic acid per gram dry matter.

14. A bottom-fermented beer according to claim 12 or 13 comprising more than 0.7 and up to 5 mg silicon per gram dry matter.

15. A bottom-fermented beer according to claims 12 to 14 comprising more than 0.8 and up to 5 mg silicon per gram dry matter.

16. A bottom-fermented beer according to claims 12 to 15 wherein the ratio of C19:0 alkylresorcinol to the sum of C17:0, C19:0, C21:0, C23:0 and C25:0 alkylresorcinols comprised in said beer is at least 16% and up to 50% (w/w).

17. A bottom-fermented beer according to claims 12 to 16 wherein the ratio of C19:0 alkylresorcinol to the sum of C17:0, C19:0, C21:0, C23:0 and C25:0 alkylresorcinols comprised in said beer is at least 18% and up to 50% (w/w).

18. A bottom-fermented beer according to claims 12 to 17 wherein the ratio of C19:0 alkylresorcinol to the sum of C17:0, C19:0, C21:0, C23:0 and C25:0 alkylresorcinols comprised in said beer is at least 20% and up to 50% (w/w).

19. A bottom fermented beer according to any of claims 12 to 18 obtained by the use of a method according to any of claims 1 to 11.
